(19) United States
(12) Patent Application Publication
(10) Pub. No.: US 2025/0316132 A1
(43) Pub. Date: Oct. 9, 2025

(54) GAMING SYSTEM WITH LINKED CROSS-CHANNEL ACTIONS

(71) Applicant: LNW Gaming, Inc., Las Vegas, NV (US)

(72) Inventors: Yaron BARTAL, Tel Aviv (IL); Eitan DAVIDSON, Herzliya (IL); Noga HALPERIN, Tel Aviv (IL); Robert J. PARENTE, Las Vegas, NV (US); Jon Christian WOLFE, Las Vegas, NV (US)

(21) Appl. No.: 19/171,496

(22) Filed: Apr. 7, 2025

Related U.S. Application Data
(60) Provisional application No. 63/631,004, filed on Apr. 8, 2024.

(51) Int. Cl. G07F 17/32; G06K 7/14

(52) U.S. Cl. CPC G07F 17/3225; G06K 7/1417; G07F 17/3211; G07F 17/3267

(57) ABSTRACT

There is provided a cross-channel gaming system comprising a gaming machine, a mobile device, and a cross-channel server for managing a cross-channel instance including a first channel and a second channel and for storing a plurality of state events linked to respective state actions for the cross-channel instance. The gaming machine presents a coded identifier that includes a channel identifier associated with the first channel for the mobile device to capture. The system extracts the channel identifier from the captured image data, links the extracted channel identifier and a second channel identifier of the second channel to the cross-channel instance, extracts at least one cross-channel data element from the second channel from the play of a second game, and causes, in response to detecting a first state event from the extracted cross-channel data element, the first channel to automatically perform a state action linked to the first state event.

### CROSS-REFERENCE TO RELATED APPLICATIONS

This patent application claims the priority benefit of U.S. Provisional Application Ser. No. 63/631,004, filed Apr. 8, 2024, the contents of which are incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to a technological improvement to gaming systems, gaming machines, and methods and, more particularly, to new and improved cross-channel gaming features.

### BACKGROUND OF THE INVENTION

The gaming industry has evolved over time to support a variety of games playable across different devices and/or different environments. At least some of these different devices and/or environments are identifiable as independent gaming “platforms” or “channels.” From a player's perspective, different gaming channels can represent different ways to experience games, such as playing a game on a floor-standing electronic gaming machine (EGM), a bartop EGM, an application installed on a mobile device, or within a web browser. Some games may be specifically designed for a given channel, while other games may be designed for multichannel deployment.

As the number of channels increases within the gaming industry, there is a desire to increase or otherwise enhance the interactions a player can have across multiple channels. One known method is having a unified player account system that the player accesses during a gaming session (or other activity, particularly for non-gaming channels). Yet a unified player account system faces several challenges, including technical challenges. Each operator and/or channel has different requirements to integrate with a third-party unified player account, such as data security requirements, regulatory requirements, different data structures, and the like. For example, different channels may use different data structures to monitor, identify, and report events occurring in a gaming session such that direct cross-channel communication would require additional and specific communication protocols to be developed and deployed for each channel. In another example, different operators may have different regulatory and/or security requirements regarding data that can be transmitted to third parties, particularly with regards to personal identification data associated with end users. In a further example, an operator may already have a player account system according to the operator's specifications, and a unified player account system would require additional development and/or computing resources to adapt to or circumvent the existing player account system. Additionally, a unified player account is reliant upon players and other end users to sign up for an account and authenticate at each channel manually to ensure that such a unified system can track the player across channels. Such implementations result in a high-friction process that may discourage some players to participate.

Accordingly, there is a need to develop a cross-channel system to facilitate extendible, flexible configurations across different technical and regulatory paradigms.

### SUMMARY OF THE INVENTION

According to an embodiment of the present invention, there is provided a cross-channel gaming system comprising a gaming machine, a mobile device, a cross-channel server, and logic circuitry. The gaming machine includes a presentation assembly configured to present a first game associated with a first channel of a plurality channels. The mobile device is associated with a player and includes at least one image sensor. The player is associated with a gaming session including play of the first game at the gaming machine. The cross-channel server is communicatively coupled to the gaming machine and the mobile device, and the cross-channel server is configured to manage a cross-channel instance including the first channel and a second channel and store a plurality of state events for the cross-channel instance, where each state event is linked to one or more respective state actions. The logic circuitry includes one or more processors and one or more memory devices configured to store instructions that, when executed by the one or more processors, causes the logic circuitry to cause the gaming machine to present, via the presentation assembly, a coded identifier that includes a channel identifier associated with the first channel and is associated with the cross-channel instance, extract, in response to the image sensor of the mobile device capturing image data including the coded identifier, the channel identifier from the image data by analyzing pixels of the image data representing the coded identifier, link, via the cross-channel server, the extracted channel identifier of the first channel and a second channel identifier associated with the second channel to the cross-channel instance, extract at least one cross-channel data element from the second channel based on the play of the second game, and cause, in response to detecting a first state event of the plurality of state events from the at least one cross-channel data element, the first channel to automatically perform at least one of the one or more respective state actions linked to the first state event.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an example cross-channel system according to an embodiment of the present invention.

FIG. 2 is a block diagram of an example cross-channel gaming system within a dedicated gaming machine channel and a mobile device channel according to an embodiment of the present invention.

FIG. 3 is a perspective view of a free-standing gaming machine according to an embodiment of the present invention.

FIG. 4 is a block diagram of a gaming system according to an embodiment of the present invention.

FIG. 5 is a flow diagram of an example method for operating a cross-channel gaming system according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

As used herein, a “gaming channel” or “gaming platform” is a defined as a set of hardware and software configured to execute game code for play of a game. The hardware may include, for example, processors, memory devices, displays, input devices, cabinets, phones, laptops, etc. The software may include, for example, operating systems, game engines, compatibility software, internet browsers, application frameworks, and the like. The game executable and each gaming channel is configured to interact in a manner that facilitates the presentation and execution of the game. While different gaming channels can share one or more hardware and/or software components, the distinction between gaming channels is delineated in each channel necessitating a change in the game executable and/or any compatibility layer of the channel to present and operate the game in an intended form. As a simplified example, a floor-standing gaming machine is a different channel from a smartphone of a player at least because of the different operating systems, the different display device configurations, and the different input methods (e.g., the gaming machine relies on buttons and/or other inputs independent of the display, whereas a smartphone typically relies on input received via a touchscreen of the display). Although the description and examples provided herein typically refer to one gaming channel being a gaming machine within a gaming environment (e.g., a casino) and another gaming channel being a mobile device of a player (e.g., a smartphone, tablet, or laptop), it is to be understood that additional or alternative gaming channels may be incorporated within the systems described below. In certain embodiments, the channels may include non-gaming channels, such as loyalty or account systems for restaurants or hotels.

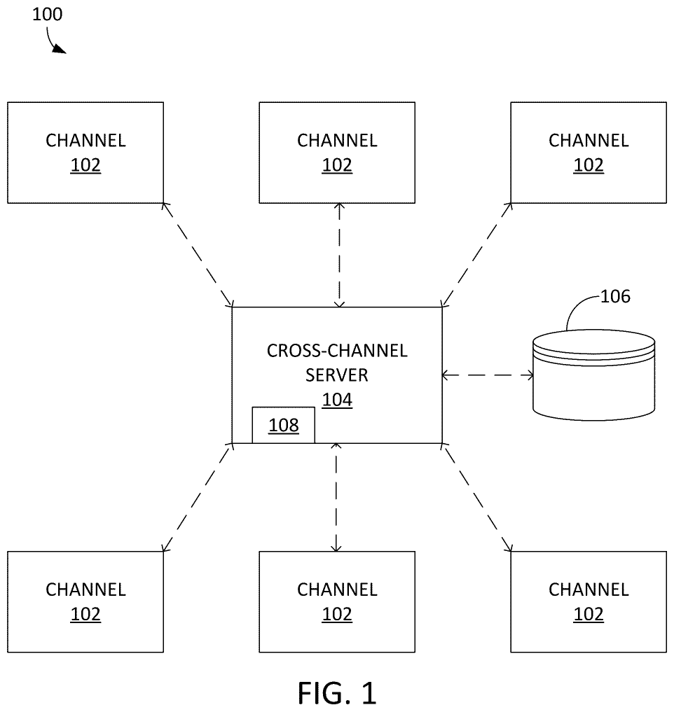

FIG. 1 is a block diagram of an example cross-channel gaming system 100 according to at least one embodiment of the present disclosure. The gaming system 100 includes a plurality of channels 102 in communication with a cross-channel server 104 and a cross-channel database 106. In other embodiments, the system 100 includes additional, fewer, or alternative devices, including those described elsewhere herein. In one example, the database 106 may be integrated within the server 104.

The channels 102 are different subsystems configured to manage a service or function within a technical architecture in a configuration that is at least partially different from other channels 102. For example, one channel 102 is configured to operate gaming machines within a casino or other gaming environment while another channel 102 is configured to operate mobile gaming applications for mobile devices (e.g., smartphones). Even to the extent that an underlying game could be played on the first and second channels, the technical differences (e.g., different software architectures, different input and output devices, etc.) between the channels requires at least one or more changes to the game executable and/or compatibility or adapter software to be applied in combination with the game executable to facilitate intended functionality of the game. In another example, two channels 102 may share the same or substantially similar technical architecture (e.g., the same gaming machines), but are deployed in different locations and/or managed by different operators. Such differences may be subject to different regulatory conditions, technical limitations, and/or security requirements. For example, channels 102 managed by different operators 102 may have secure data limitations that prevent direct cross-channel communication.

The channels 102 may be associated with gaming platforms and/or other suitable non-gaming platforms. Each channel 102 includes an end-user-facing functionality, such as playable games, purchasable goods or services, and the like. The end-user-facing functionality may include sessions (e.g., gaming sessions), end user accounts, applications, and/or other suitable user identifiable aspects that can be attributed to a particular end user interacting with the channel 102, even end users that are anonymous beyond the interaction with a given channel 102. The underlying hardware and/or software of each channel 102 is configured to facilitate the specific functions of the channel 102. For example, gaming machines, gaming applications, servers, kiosks, terminals, and/or other suitable hardware and software are used to define each channel 102.

The cross-channel server 104 is communicatively coupled to each channel 102 to facilitate cross-channel functionality as described herein. In the example embodiment, the cross-channel server 104 is configured to link an end user across multiple channels 102. Based on the link, the cross-channel server 104 is configured to monitor, extract, and analyze data elements from one linked channel 102 to automatically perform one or more actions within a second linked channel 102. The cross-channel server 104 is associated with one or more communication interfaces (e.g., an application programming interface (API), web interface, etc.) that conform to the technical, regulatory, security, and other specifications of communication with each channel 102. For example, a channel 102 associated with a secure, land-based casino gaming environment may use a secure communication interface that differs from the interface of a channel 102 associated with mobile computing devices, such as in the manner in which the channels 102 authenticate communication, the type of available data and/or commands, and the like.

The cross-channel server 104 includes logic circuitry 108 to perform the functions of the server 104 as described herein. The logic circuitry 108 includes one or more processors, storage devices, network devices, and the like that facilitate execution, storage, and transmission of data and executable instructions. The logic circuitry 108 and the server 104 itself may be within a single device or a distributed system. That is, resources of the server 104 and/or the logic circuitry 108 are spread across a plurality of communicatively coupled devices within a distributed system. It is to be understood that any servers as described herein may include logic circuitry similar to the logic circuitry 108 and/or are provided as standalone or distributed servers.

In the example embodiment, the cross-channel database 106 is in communication with the cross-channel server 104. The cross-channel database 106 may be a single device or a distributed system configured to store data in structured formats, particularly data associated with the system 100. A structured data format enables the cross-channel database 106 to store a collection of data elements that are linked together as a data object and facilitate streamlined identification of linked data (i.e., storing data element relationships reduces the computing resources needed to identify related data each time data is requested or changed) and propagation of changes across linked data elements. In other embodiments, the cross-channel database 106 is at least partially integrated with the cross-channel server 104 such that at least some of the data stored by the database 106 is locally stored by the server 104. In certain embodiments, the database 106 may be additionally or alternatively distributed within one or more channels 102. In such embodiments, the database 106 is accessible by the cross-channel server 104 directly or indirectly via communication with the channels 102.

The cross-channel database 106 is configured to store cross-channel instances in a manner that enables the cross-channel server 104 to lookup, retrieve, and/or alter the stored data associated with the instances. A cross-channel instance is associated with a particular end user or group of end users and includes data elements known as “channel identifiers” for identifying sessions, accounts, and the like of the end user across a plurality of linked channels 102. In addition to channel identifiers, a channel instance includes a predefined set of cross-channel events that represent different conditions and/or events detectable within one or more of the linked channels 102. Each event is associated with one or more cross-channel reactions stored with the instance. The cross-channel server 104 is configured to collect data elements from the linked channels 102 and determine if any cross-channel events have occurred. If an event has occurred, the cross-channel server 104 is configured to automatically cause an associated cross-channel reaction to be performed by one or more channels.

In one example, an end user is playing a game on a gaming machine representing a first channel. During play of the game, the gaming machine advertises a second channel available to play the same or another game, such as within a gaming application executable by a smartphone of the end user. It is to be understood that the “same” game in this example does not mean an identical set of executable data, but rather that the end user would still identify the game as the “same” from an experience standpoint despite the technical differences arising from the differences in the underlying channels. The advertisement includes a method to automatically guide the end user to the second channel, such as a quick response (QR) code presented by the gaming machine to be captured by a camera of the smartphone of the end user to guide the end user to an application storefront or download center that downloads a gaming application on the smartphone. The QR code may be presented via a physical badge, sticker, or other element affixed to the gaming machine or otherwise available in an area associated with the gaming machine (e.g., a kiosk or poster stand positioned near the gaming machine). In other embodiments, the QR code is presented digitally via an electronic display device to facilitate presentation of different QR codes, including QR codes that are updated over the course of the gaming session at the gaming machine. The cross-channel server 104 stores identifiers associated with both channels in a cross-channel instance in response to the QR code being scanned. In response to the cross-channel instance being initialized, the cross-channel server 104 monitors the channels for cross-channel events. The monitoring may be active (e.g., the cross-channel 104 actively requests data regarding the cross-channel events from the channels) or inactive in which the channels proactively report data associated with the cross-channel events. The cross-channel events include an event to attribute funds received via the gaming application to play a game (e.g., wagers) to an operator of the first channel. That is, one event is defined to detect every wager or other purchase made within the gaming application of the second channel and tracks an amount of revenue to be shared to the first channel within a corresponding cross-channel reaction. However, the cross-channel interaction of this example is not limited to a single detectable event. In this example, the cross-channel instance includes a cross-channel campaign, where the player performs tasks within the game of at least one channel to receive an award. One example campaign may include playing the game for a certain number of outcomes or a predefined period of time within the gaming application of the smartphone to receive free spins or bonus symbols within the game at the gaming machine of the first channel.

In another example, an end user has a mobile application installed on the mobile device of the end user that is associated with a first channel. The mobile application is configured to access one or more location identifiers of the mobile device, such as a Global Positioning System (GPS) signal, wireless data signal, cellular signal, and the like, to determine whether or not the end user is located within proximity to a gaming environment associated with a second channel. If the user is determined to be within a predefined proximity of the environment of the second channel, the cross-channel instance causes the mobile application to automatically push a notification to the end user promoting the end user to visit the gaming environment of the second channel and perform one or more tasks to collect an award and/or be entered within a sweepstakes. In some embodiments, the cross-channel instance is configured to streamline the end user through an enrollment process for a loyalty account with the gaming environment of the second channel by providing the enrollment via the mobile application or mobile device automatically and/or providing at least some enrollment data from the mobile application to the second channel to reduce the amount of information the end user is required to manually input.

In a further example, the end user participates within a multichannel game by playing one or more games across multiple channels. That is, in response to linking the end user to two or more channel sessions (e.g., gaming sessions occurring at different channels), the cross-channel server 104 monitors game events occurring within each session relative to one or more tasks, trigger events, and the like. In certain embodiments, the multichannel game includes one or more tasks for the end user to complete according to predefined criteria within each linked channel. For example, the end user must reach or exceed a threshold associated with a number or an amount of wagers, awards, and/or outcomes within each channel. The cross-channel server 104 is configured to monitor progression towards each task and provide, via one or more of the linked channels, a visual indication of the progression towards each task. Upon completing each task and/or all of the tasks, an award is provided to the end user via the linked channels and/or another channel. For example, completing the tasks may result in a non-gaming award, such as a discount at a restaurant or hotel.

To facilitate the data communication and automated actions of the cross-channel gaming system 100, the cross-channel server 104 is configured to operate using a plurality of different application programming interfaces (APIs) to interface with the channels 102. That is, the APIs enable the server 104 to be integrated with a plurality of channels 102 that operate using varying data structures, data security measures, and/or other technical considerations. The APIs enables operators of each channel 102 to specify which data and responsive actions are facilitated by the respective channel 102, thereby enabling the cross-channel server 104 to interact without requiring full control of the channel 102. In certain embodiments, the APIs are configured to be backwards compatible with existing channel infrastructure by adopting an API configuration used by existing devices within the channel 102, which may reduce or otherwise eliminate the need for each channel 102 to be adjusted or require new configuration to adopt the cross-channel system 100.

The APIs are configured to include identifiers for specifying which user, device, and/or the like is associated with a particular API call. For example, the identifier may include preexisting identifiers for player accounts, gaming sessions, or gaming machines that are already used in other systems beyond the scope of the system 100. In other embodiments, the identifiers for the system 100 may be uniquely generated without accessing identifiers from the channels 102. In such an embodiment, the channels 102 may be configured to link the unique cross-channel identifier with the channel-specific identifiers to facilitate the functionality described herein.

In addition to identifiers, the APIs include data structures and/or executable instructions for prompting the underlying devices of the channels 102 to automatically provide predefined data to the server 104 and/or automatically perform predefined actions. The predefined data and actions are tailored to the configuration of each channel and the intended functionality of each cross-channel instance. The cross-channel server 104 is configured to collect the predefined data, compare the data to one or more trigger events or conditions associated with one or more predefined actions, and determines whether or not a given action should be triggered in any of the linked channels (including the channel the predefined data originates from). By performing the collection and analysis of the data by the cross-channel server 104 and the different APIs, cross-channel functionality can be provided without requiring a direct, bespoke interface between different channels, which can result in increased complexity of the system configuration and reduce the ability of such a system from providing scalable functionality to new channels.

In at least some embodiments, the cross-channel server 104 is configured to monitor progression towards one or more tasks and provide an outbound API for different channels to monitor the status or state of the task progression dynamically. That is, some channels may provide a graphical interface or a portion of an interface for the end user to monitor his or her progression within the cross-channel instance. For example, a meter or other visual element is presented and dynamically updated within a graphical interface for the player to monitor their progression. In certain embodiments, a channel may use the progression as indicated by the cross-channel server 104 to change the session of the end user, provide new or altered events, and the like based on the current progression. In one example, a game interface of a channel may include visual elements that change as the player progresses towards a goal or task completion within another linked channel. In another example, at predefined increments of progression within the first channel, a game at the second channel awards additional wild symbols or free spins to encourage the player to keep progressing within the first channel. It is to be understood that the specific visual representation of progression may be adjusted according to the particular configuration of the task and/or the interface in which the progression is presented.

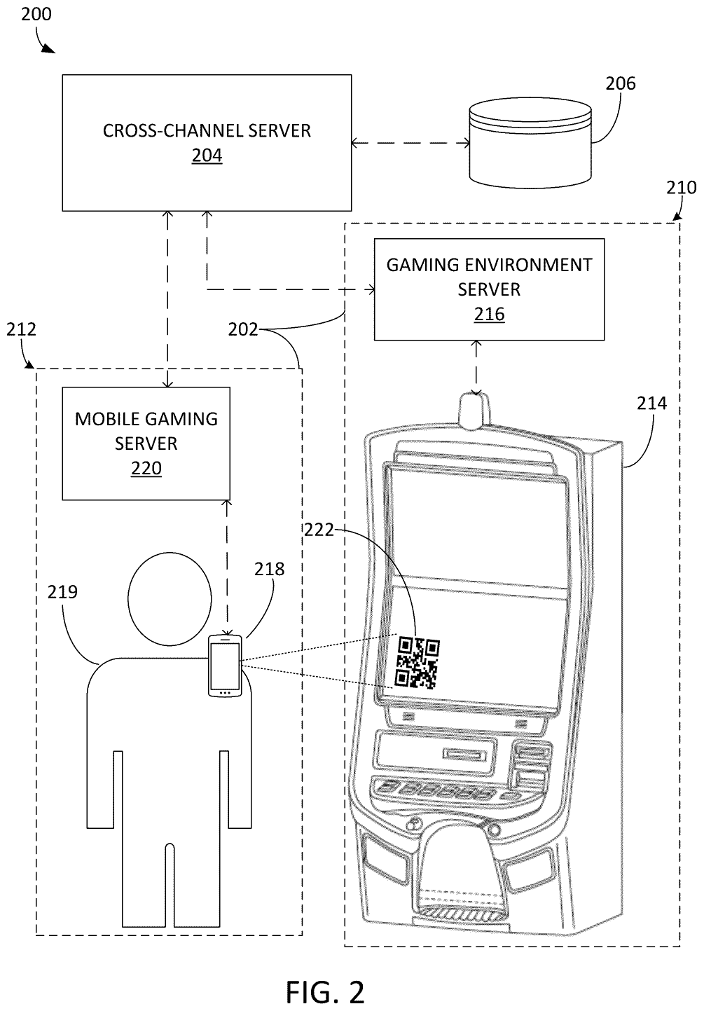

FIG. 2 is a block diagram of an example cross-channel gaming system 200 according to at least one embodiment of the present disclosure. In the example embodiment, the system 200 is similar to the system 100 shown in FIG. 1. The system 200 includes two channel 202, a cross-channel server 204, and a cross-channel database 206 communicatively coupled together. In this example, the two channels 202 include a first channel 210 and a second channel 212. The first channel 210 is associated with a gaming environment (e.g., a casino) and includes a gaming machine 214 and a gaming environment (GE) server 216 in communication with the cross-channel server 204. The second channel 212 is associated with a mobile gaming environment using player mobile devices. More specifically, the second channel 212 includes a mobile device 218 and a mobile gaming (MG) server 220 in communication with the cross-channel server 204. In other embodiments, the system 200 includes additional, fewer, or alternative devices and subsystems, including those described elsewhere herein. In one example, the system 200 includes additional or alternative channels 202. In another example, the servers 204, 216, and 220 may be at least partially integrated with each other to provide the functionality described herein. In a further example, the system 200 has a different configuration relative to the configuration of the system 100.

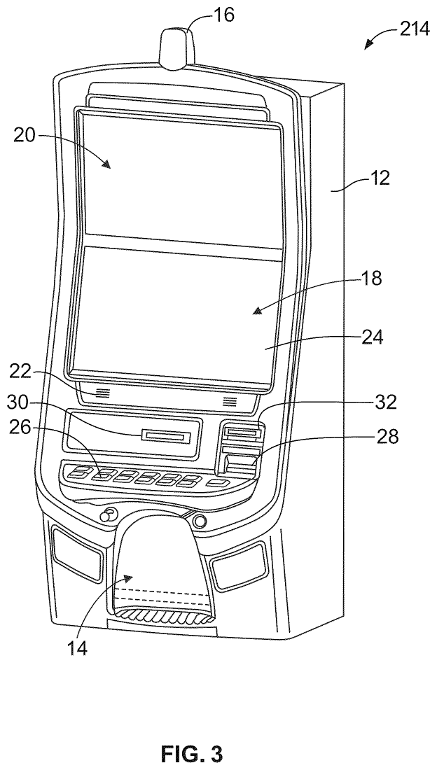

With respect to the first channel 210, the gaming machine 214 is shown in further detail in FIG. 3. The gaming machine 214 is similar to those operated in gaming establishments, such as casinos. With regard to the present invention, the gaming machine 214 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 214 may take any suitable form, such as floor-standing models as shown, handheld mobile units, bartop models, workstation-type console models, etc. Further, the gaming machine 214 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 214 illustrated in FIG. 3 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 214.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 214. The presentation assembly may include one presentation device (e.g., the primary presentation device 18), some of the presentation devices of the gaming machine 214, or all of the presentation devices of the gaming machine 214. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 214. The presentation assembly is configured to present digital presentation sequences through one or more graphical user interfaces (GUIs). Each GUI may be presented by a single device or a plurality of devices (e.g., the presentation devices 18, 20). Graphical data is stored and generated by the gaming machine 214 in data structures that, when executed by the electronic display controllers of the gaming system, cause the electronic displays to present the GUI according to the particular events and information representing the current state of an active gaming session (or other non-gaming states of the machine 214 when a gaming session is not currently active).

The gaming machine 214 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 214 includes one or more value input/payment devices and value output/payout devices. In order to deposit cash or credits onto the gaming machine 214, the value input devices are configured to detect a physical item associated with a monetary value that establishes a credit balance on a credit meter presented by the presentation assembly. The physical item may, for example, be currency bills, coins, tickets, vouchers, coupons, cards, and/or computer-readable storage mediums. The deposited cash or credits are used to fund wagers placed on the wagering game played via the gaming machine 214. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the credits meter, the value output devices are used to dispense cash or credits from the gaming machine 214. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

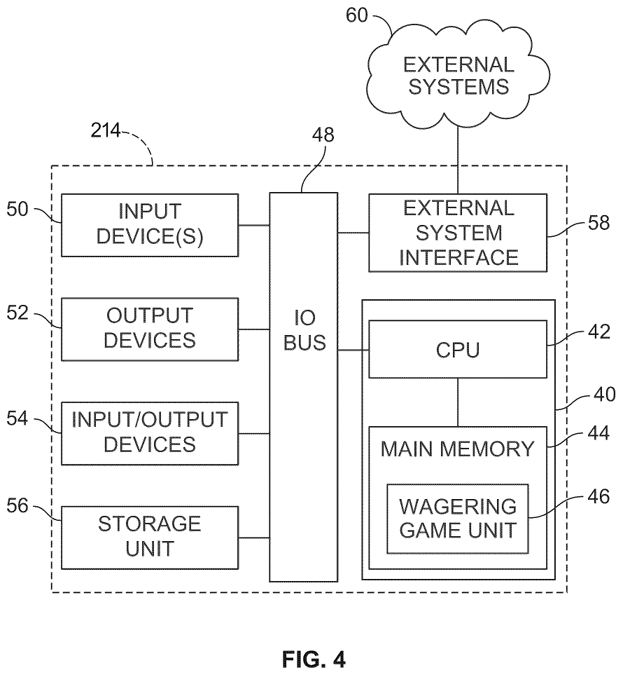

Turning now to FIG. 4, there is shown a block diagram of the gaming-machine architecture according to at least one embodiment of the present disclosure. The gaming machine 214 includes game-logic circuitry 40 securely housed within a locked box inside the gaming cabinet 12 (see FIG. 3). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 214 that is configured to communicate with or control the transfer of data between the gaming machine 214 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 3. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. For example, the external system 60 may be or may include the gaming environment server 216 (shown in FIG. 2). In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 214, such as by a near-field communication path operating via magnetic-field induction or a frequency-hopping spread spectrum RF signals (e.g., Bluetooth, etc.).

The gaming machine 214 optionally communicates with the external system 60 such that the gaming machine 214 operates as a thin, thick, or intermediate client. The game-logic circuitry 40-whether located within (“thick client”), external to (“thin client”), or distributed both within and external to (“intermediate client”) the gaming machine 214—is utilized to provide a wagering game on the gaming machine 214. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 214, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 214 by accessing the associated game assets, required for the resultant outcome, from the main memory 44. The CPU 42 causes the game assets to be presented to the player as outputs from the gaming machine 214 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 214 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 214 may include additional peripheral devices or more than one of each component shown in FIG. 4. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 214 depicted in FIG. 1, following receipt of an input from the player to initiate a wagering-game instance. The gaming machine 214 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 214 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 214, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 214 may be implemented with hardware and software architectures, circuitry, and other special features that differentiate it from general-purpose computers (e.g., desktop PCs, laptops, and tablets).

Referring back to FIG. 2, the gaming machine 214 is configured to facilitate a gaming session associated with at least one cross-channel instance maintained by the cross-channel server 204. In the example embodiment, the cross-channel instance includes a multichannel game. The multichannel game includes at least one additional version beyond the version executable by the gaming machine 214 that is performed on a different gaming channel. In the example embodiment, the multichannel game is configured to be executable on the mobile device 218 as a game application natively installed on the device 218 or within a web browser of the mobile device 218. In other embodiments, the multichannel game includes additional or alternative versions that may be executed on other suitable devices. The mobile device 218 is a device owned or otherwise possessed by a player 219. The player 219 is present at the gaming machine 214 to play the multichannel game.

In the example embodiment, the gaming machine 214 is communicatively coupled to the GE server 216. The GE server 216 is configured to monitor the gaming session at the gaming machine 214 and perform one or more functions that facilitate the operation of the gaming machine 214. For example, the GE server 216 may be configured to provide one or more game functionalities (e.g., determining game outcomes, validating wagers, awards, and other transactions, linking player accounts to the gaming session, and the like). The GE server 216 may be associated with a particular gaming environment, such as a casino, or may be associated with a plurality of environments of an operator that has deployed the gaming machine 214.

Similar to the gaming machine 214 and the GE server 216, the mobile device 218 is communicatively coupled to the mobile gaming (MG) server 220 to facilitate functionalities associated with the multichannel game. In some embodiments, one or more executable gaming applications are locally stored by the mobile device 218, and the MG server 220 interacts with the mobile device 218 based on the code execution of the one or more gaming applications. In one example, the underlying game determinations are performed by the MG server 220 and are communicated to the mobile device 218 for presentation. In another example, the MG server 220 is configured to detect gaming sessions initiated by the mobile device 218 and/or events associated with the gaming sessions.

The cross-channel server 204 is communicatively coupled to the GE server 216 and the MG server 220 to facilitate cross-channel functionality of the system 100. Cross-channel functionality may include, but is not limited to, presenting players with loyalty rewards or incentives to play a multichannel game on a different channel, providing players with streamlined access to games on another channel (e.g., automated installation of a game application or automated initiation of a gaming session), and/or linking gaming sessions across gaming channels to facilitate cross-channel game events, awards, and/or credit balances.

The GE server 216 and the MG server 220 are configured to manage gaming sessions for the respective gaming channels and may not be configured to directly monitor or manage cross-channel games. In some embodiments, the GE server 216 and the MG server 220 may be independently managed by different operators, and each operator may desire to limit the exposure of data between channels for data security purposes, particularly for regulated gaming channels. Additionally or alternatively, the gaming data collected and stored from the gaming sessions of each gaming channel may have different structures and/or data elements that prevent the gaming data from being directly compatible with other gaming channels for the functions described herein.

Accordingly, the cross-channel server 204 is configured to facilitate cross-channel instances, where each cross-channel instances includes a set of predefined criteria that identifies, for example and without limitation, the participating channels, one or more data elements to be monitored at a given channel, what actions (automated and/or performed by the player) are required, and any linked response actions that automatically occur in response to a particular action or condition detected at another channel within the cross-channel instance. The cross-channel server 204 is configured to store the predefined criteria of each cross-channel instance in a manner that enables multiple instances with different predefined criteria to be active at a given time.

In the example embodiment, the cross-channel server 204 is configured to manage at least one cross-channel instance including the first channel 210 associated with the gaming machine 214 and the second channel 212 associated with the mobile device 218. More specifically, the example cross-channel instance is configured to link the gaming session of the player 219 at the gaming machine 214 to a game application executable by the mobile device 218. Based on the cross-channel link, actions performed at the mobile device 218 using the game application, one or more linked response actions may occur within the first channel 210. In one example, the cross-channel instance links wagers, credit balances, and/or awards from the second channel 212 to the first channel 210 to create a shared funding model. In another example, game-oriented tasks are assigned for at least one of the first and second channels 210, 212, and completing said tasks provides an award, which may be applied at the first and/or second channels 210, 212 (e.g., bonus spins, credit awards, etc.) or applied at a different channel linked to the instance, including non-gaming channels. That is, the award may be external to gaming, such as entry into an award sweepstakes, a free beverage, and the like.

The cross-channel server 204 is communicatively coupled to the cross-channel database 206 to store data associated with the cross-channel instances. The cross-channel database 206 includes one or more data storage mediums (e.g., hard drives) for storing data in an indexed, retrievable structure. The database 206 may be formed by a single device or a distributed database system, where the computing, storage, and/or networking resources of the database 206 are distributed across a plurality of interconnected devices. In other embodiments, the database 206 is at least partially integrated with the cross-channel server 204 and/or another suitable computing device, such as the servers 216, 220.

The database 206 is configured to store data elements for linking player or user interactions with the system 200 across multiple channels. For example, to link the player 219 to the first channel 210 associated with the gaming machine 214 and the second channel 212 associated with the mobile device 218, the database 206 stores at least one respective channel identifier for each of the first and second channels 210, 212 in a configuration that the cross-channel server 204 and/or an operator managing the database 206 could readily recognize the relationship between the first and second channels 210, 212. It is to be understood that various database configurations and schemes may be used to convey the linked relationship between stored data elements, such as tables, pointers, linked lists, and the like.

In at least some embodiments, the cross-channel instances of the system 200 facilitate enhanced discoverability and exposure of different channels that the players may not otherwise experience. In the example embodiment, a cross-channel instance is available between the first and second channels 210, 212. The player 219 is participating in a gaming session at the gaming machine 214. The gaming machine 214 is configured to provide one or more means for the player to activate a cross-channel instance with the second channel 212. More specifically, the gaming machine 214 is configured to present an optical coded identifier 222 via the presentation assembly of the gaming machine 214 for the player 219 to scan. The optical coded identifier 222 in FIG. 2 is a QR code, which stored encoded data in a machine-readable format. The coded identifier 222 is generated by the cross-channel server 204, the gaming machine 214, and/or the GE server 216 such that the data represented by the identifier 222, either directly through decoding the data of the identifier 222 or indirectly by retrieving the data via a link or pointer indicating the data location, can be uniquely linked to the player 219. In one example, the coded identifier 222 includes a machine identifier for the gaming machine 214 and/or a player identifier for the player 219, where the player identifier is a player account number, a uniquely generated identifier for the gaming session, and the like. In certain embodiments, to prevent others from initiating the cross-channel instance using the session of the player 219, the coded identifier 222 includes one or more random values that are refreshed or regenerated periodically.

The mobile device 218 includes one or more image sensors (e.g., a camera) for capturing image data. If the player 219 elects to initiate a cross-channel instance, the player 219 uses the image sensors of the mobile device 218 to capture image data including the optical coded identifier 222. In response to capturing the image data, the mobile device 218 is configured to decode the identifier 222 by analyzing the pixels of the image data representing the identifier 222. The extracted data may include identifiers, links, and/or instructions to facilitate the cross-channel instance. For example, the extracted data may include a link to direct the mobile device 218 to an application store to download a gaming application associated with the second channel 212 or to direct the mobile device to a webpage of a web-based game associated with the second channel 212. Any identifiers for linking the first channel 210 to the second channel 212 may be passed forward to the gaming application or gaming webpage. In certain embodiments, rather than exchanging identifiers through the QR code, the gaming application or webpage may include identifiers that are passed to the gaming machine 214 to initiate the cross-channel instance, such as a QR code presented by the mobile device 218 to be scanned by the gaming machine 214.

In certain embodiments, in addition to or in place of the optical coded identifier 222, other suitable methods of communicating unique identifiers across channels may be used to initiate a cross-channel instance. For example, the gaming machine 214 and the mobile device 218 may be configured to communicate via wired or wireless data networks, or the player 219 registers for the cross-channel instance at a kiosk associated with the first channel such that the player 219 presents a ticket or account number at the machine 214 to initiate the cross-channel instance.

The cross-channel server 204 is configured to retrieve channel identifiers from both the first and second channels 210, 212 to initiate the cross-channel instance. In at least some embodiments, the channel identifiers are provided via the second channel 212 by transmitting the extracted channel identifier from the first channel 210 with an identifier generated for the mobile device 218 and/or the player 219 for the second channel 212. The cross-channel server 204, via the cross-channel database 206, is configured to store the linked channel identifiers with a set of predefined state events as a cross-channel instance. Each state event represents a trigger event and/or condition for initiating one or more actions within the linked channels, particularly within other linked channels. Accordingly, the stored cross-channel instance includes one or more state reactions for each state event that predefines an action to be taken in response to the state event. In some embodiments, rather than storing the state reactions at the cross-channel server 204 and the cross-channel database 206, the reactions are defined within each channel such that the cross-channel server 204 notifies the channels of a state event occurring without specifying an action to be taken. For example, the state events may include installing a gaming application, playing a certain number of outcomes within a gaming session, or visiting a gaming environment, while the state reactions may include providing an in-game award, changing a graphical interface of a game, entering the player 219 into a sweepstakes, and the like. Other suitable events and reactions may be configured based on the specific configuration of each channel within the instance.

The cross-channel instance may be maintained indefinitely, for a predefined period of time, in response to user input (e.g., a player can opt-in or opt-out of the instance), and the like. In some embodiments, additional information, such as a player identifier, is required to maintain a cross-channel instance after the user ends a session at one or more channels within the cross-channel instance. For example, if a mobile game application is installed on a player's phone following the player scanning a QR code on a gaming machine at which the player is present, the cross-channel instance and the corresponding cross-channel events and actions are active until the gaming sessions on the gaming machine and/or the mobile game application have been terminated. Removal of a cross-channel instance may cause the cross-channel database 206 to remove the data associated with the instance or maintain the data in an inactive or archival state. In another example, the cross-channel instance is maintained until a final or termination action is performed. For example, a number of free spins or wild symbols may be awarded based on cross-channel activity, and the cross-channel instance may be removed in response to all of the free spins or symbols being awarded.

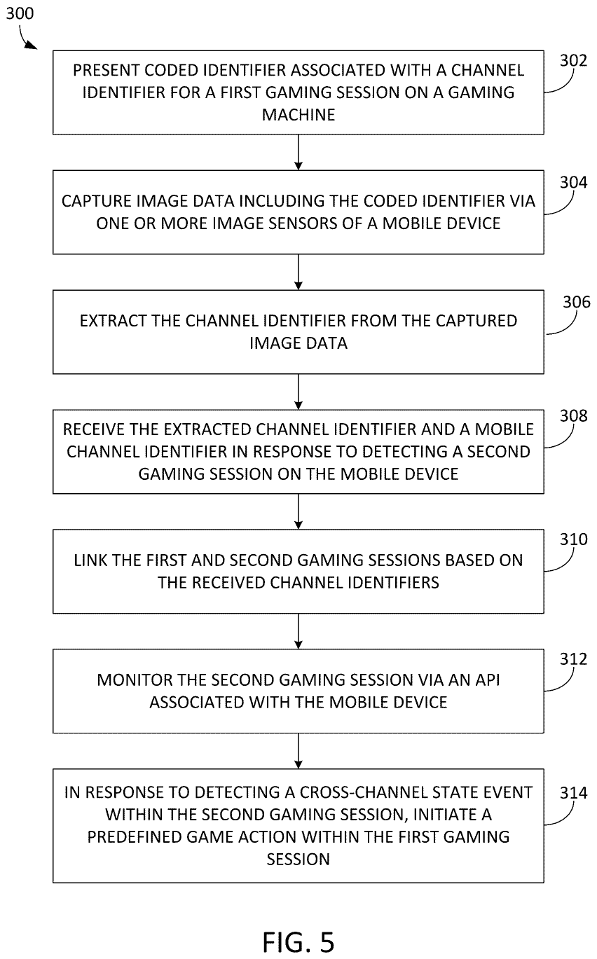

FIG. 5 depicts an example method 300 for operating a cross-channel gaming system, such as the systems 100, 200 shown in FIGS. 1 and 2, respectively. The method 300 in particular provides a method for linking a gaming machine and mobile device together and performing actions within the game of one channel based on the events occurring within the game of another channel. The method 300 is configured to be performed using a cross-channel server and communicatively coupled devices within each of the two channels, such as channel-specific servers and/or the underlying gaming devices as described herein. It is to be understood that although the method 300 is described herein with respect to two gaming channels for providing cross-channel functionality within the gaming sessions of each channel, the cross-channel functionality is not limited to gaming-specific channels nor is the functionality limited to the specific examples provided herein.

The method 300 begins with a player playing a game at a dedicated gaming machine, such as the gaming machine 214 shown in FIG. 2. The game at the gaming machine represents a first channel or channel enrolled in a multichannel system. In some embodiments, an operator managing the gaming machine and/or the game is provided an option to selectively enroll (or selectively opt out) within the multichannel system. In other embodiments, the enrollment is automated and integrated within the game and/or the gaming machine (e.g., within the underlying software of the gaming machine). In the example embodiment, the operator has enrolled the game and/or gaming machine into a cross-channel instance. The cross-channel instance is associated with the first channel and at least one additional channel, where the instance includes predefined criteria, tasks, and automated actions that are divided across two or more enrolled channels. That is, the functionality of the instance is divided into linked tasks or functions spanning at least two channels to facilitate player participation across multiple channels.

At step 302, the gaming machine of the first channel presents, via a presentation assembly, a quick response (QR) code. More specifically, the gaming machine generates a QR code that is associated with one or more channel identifiers that are extracted or otherwise reconstructed based on analysis of the QR code as described herein. The channel identifier is a data element or data structure (i.e., multiple data elements) that identifies one or more aspects of the gaming session via the first channel (known sometimes herein as the “first gaming session”), particularly for linking with current or future sessions in other channels. For example, and without limitation, the channel identifiers may include a machine identifier, a player identifier, a game identifier, a location identifier (e.g., for identifying a casino or other establishment including the gaming machine), and/or other suitable identifiable data. In other embodiments, other suitable coded identifiers may be presented by the gaming machine, such as a barcode, and/or the coded identifier is presented on a different medium, such as a ticket printed by the machine or a kiosk. In further embodiments, the channel identifiers are not extracted based on visually presented identifier, but instead the channel identifiers are retrieved using other suitable data transmission configurations, such as wireless or wired communication between the gaming machine and the mobile device.

At step 304, one or more image sensors of the mobile device capture image data including the QR code presented by the gaming machine. The image data may be a photo captured by the mobile device or a video stream (e.g., a preview view of a camera application installed on the mobile device). The QR code is an optical code that, through different visible patterns, provide a machine readable format with a predefined encoding architecture to facilitate decoding by at least some computing devices. At step 306, the mobile device is configured to extract the channel identifier associated with the first gaming session from the QR code. In some embodiments, the mobile device passes the captured image data to another device, such as the cross-channel server or another suitable server, to extract the identifier. In other embodiments, the encoded data does not directly include the channel identifier for the first channel, but rather the channel identifier is retrievable based on the encoded data. For example, the encoded data may be a unique link for the mobile device to access, where accessing the unique link exposes the channel identifier for retrieval by the mobile device or the cross-channel server.

In some embodiments, the extracted data from the coded identifier causes the mobile device to automatically be directed to a gaming application or webpage associated with the second channel. That is, the player associated with the mobile device is directed to install or otherwise play a game on his or her mobile device, and the coded identifier reduces the number of manual steps required to locate and begin playing the game promoted by the first channel at the gaming machine. In response to detecting that the player has initiated a gaming session for a second game or installed a gaming application for the second game based on the extracted data, a new channel identifier is generated or otherwise linked to the first channel identifier. At step 308, the cross-channel server is configured to receive the two channel identifiers (e.g., via the mobile device and/or other devices of the second channel) and, at step 310, link the first and second gaming sessions together within a cross-channel instance.

The cross-channel instance not only identifies, via the channel identifiers, two gaming sessions that are linked together, but also includes one or more events, conditions, and/or actions that can be performed across linked channels. For example, the cross-channel server is configured to monitor the second gaming session at the mobile device for one or more predefined state events, such as a particular game event or reaching a threshold number of a particular game event at step 312. The cross-channel server is configured to support a plurality of channel-specific APIs that enable certain predefined data to be shared with the cross-channel server, particularly data used to detect the state events. At step 314, in response to detecting a cross-channel state event within the second gaming session, the cross-channel server is configured to initiate (or otherwise cause the gaming machine to initiate) a corresponding predefined game action within the first gaming session. For example, if the state event includes playing a certain number of outcomes within the second gaming session, the game action within the first gaming session may include adding wild symbols or enhancing value-bearing symbols for one or more subsequent outcomes of the first gaming session.

The systems and methods above provide a distinct, technical improvement over known gaming systems using unified player account and tracking methods that rely upon a player providing a unique user credentials for each session at various channels. Preexisting channels and/or channels with different operators or technical limitations have different player accounting systems, including some channels without the capability of tracking players. To provide a unified player account system, computing and presentation resources must be adapted to the specifications of the unified account system (e.g., data stream structure, permissions to receive certain user inputs, etc.) and/or the unified account system is available in combination with other account systems provided by the channels, thereby creating complexity and confusion for end users being prompted for a plurality of different accounts. Additionally, for each account system, additional authentication steps are implemented at each channel to ensure the end user associated with a given session is also associated with the unique identifier. Each authentication step (e.g., prompting a user for a password, passkey, biometric input, etc.) provides friction between an end user and the sessions at each channel. While said authentication works to verify the player identity relative to the unique identifier, the manual steps taken by the player slow down the process of engaging with the various channels and also lack user motivation for linking different sessions when the cross-channel actions and/or events affect other associated parties (e.g., operators of different channels).

In contrast, the systems and methods described above authenticate the relationship between two channels through a “trusted” physical device (e.g., a user's phone) capable of capturing image data at a gaming machine or other suitable device. The phone or other user device can be assumed as representative of a given player for identification purposes, and capturing image data of a coded identifier at a gaming machine infers the player is physically present at the gaming machine participating in a gaming session. The captured coded identifier results in automatic guidance to and/or installation of applications or other suitable channels, thereby decreasing the friction between a player and discovery of other channels relative to advertising or manual channel discovery. That is, the systems and methods of the present disclosure provide a streamlined, technical solution to by providing end users with an efficient method for discovering new channels in exchange for a single, cross-channel authentication relying upon a user's computing device and captured image data. The resulting cross-channel instance is initialized without requiring the player to make an account (enabling anonymous tracking), reduces or eliminates the player accounts a user needs to verify at each channel, and/or provides an incentive to players to link cross-channel activity even if the resulting cross-channel events and/or actions do not affect the player (e.g., events and actions associated with operators of different channels). Moreover, the APIs between the cross-channel server and the different channels enable the system to adapt to various preexisting data streams, data structures, and other limitations of each channel to the cross-channel gaming system without necessitating existing channels be adapted to a single, predefined data format accepted by the cross-channel server, thereby reducing the development and computing resources attributed to the cross-channel system.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A cross-channel gaming system comprising:
a gaming machine comprising a presentation assembly configured to present a first game associated with a first channel of a plurality channels;
a mobile device associated with a player and comprising at least one image sensor, wherein the player is associated with a first gaming session including play of the first game at the gaming machine;
a cross-channel server communicatively coupled to the gaming machine and the mobile device, the cross-channel server configured to manage a cross-channel instance including the first channel and a second channel associated with a second game, the cross-channel server storing a plurality of state events for the cross-channel instance, each state event of the plurality of state events linked to one or more respective state actions; and
logic circuitry comprising one or more processors and one or more memory devices configured to store instructions that, when executed by the one or more processors, causes the logic circuitry to:
cause the gaming machine to present, via the presentation assembly, a coded identifier associated with the cross-channel instance, the coded identifier including a channel identifier associated with the first channel;
in response to the at least one image sensor of the mobile device capturing image data including the coded identifier, extract the channel identifier from the image data by analyzing pixels of the image data representing the coded identifier;
link, via the cross-channel server, the extracted channel identifier of the first channel and a second channel identifier associated with the second channel to the cross-channel instance;
extract at least one cross-channel data element from the second channel based on a second gaming session including play of the second game; and
in response to detecting a first state event of the plurality of state events from the at least one cross-channel data element, cause the first channel to automatically perform at least one of the one or more respective state actions linked to the first state event.

2. The cross-channel gaming system of claim 1, wherein the presentation assembly is configured to present a state meter to visually indicate progress towards the first state event based on the play of the second game.

3. The cross-channel gaming system of claim 1, wherein, in response to extracting the channel identifier from the image data, an application associated with the second game of the second channel is automatically installed on the mobile device.

4. The cross-channel gaming system of claim 1, wherein the coded identifier is a quick response (QR) code.

5. The cross-channel gaming system of claim 1, wherein the logic circuitry is configured to verify the extracted channel identifier with the gaming machine to link the extracted channel identifier to the second channel identifier.

6. The cross-channel gaming system of claim 1, wherein the cross-channel instance is removed in response to at least one of the first gaming session or the second gaming session concluding.

7. The cross-channel gaming system of claim 1, wherein the one or more respective state actions includes awarding at least one of a number of free spins, a number of wild symbols, or a number of bonus trigger symbols within the first game.

8. A method of operating a cross-channel gaming system, the cross-channel gaming system comprising a gaming machine, a mobile device associated with a player, a cross-channel server communicatively coupled to the gaming machine and the mobile device, and logic circuitry, wherein the player is associated with a first gaming session including play of a first game at the gaming machine, the method comprising:
presenting, via a presentation assembly of the gaming machine, the first game associated with a first channel of a plurality channels for the first gaming session;
storing, by the cross-channel server, a plurality of state events for a cross-channel instance including the first channel and a second channel associated with a second game, each state event of the plurality of state events linked to one or more respective state actions;
causing, by the logic circuitry, the gaming machine to present, via the presentation assembly, a coded identifier associated with the cross-channel instance, the coded identifier including a channel identifier associated with a first channel;
in response to at least one image sensor of the mobile device capturing image data including the coded identifier, extracting, by the logic circuitry, the channel identifier from the image data by analyzing pixels of the image data representing the coded identifier;
linking, via the cross-channel server, the extracted channel identifier of the first channel and a second channel identifier associated with the second channel to the cross-channel instance;
extracting, by the logic circuitry, at least one cross-channel data element from the second channel based on a second gaming session including play of the second game; and
in response to detecting a first state event of the plurality of state events from the at least one cross-channel data element, causing, by the logic circuitry, the first channel to automatically perform at least one of the one or more respective state actions linked to the first state event.

9. The method of claim 8, wherein the presentation assembly is configured to present a state meter to visually indicate progress towards the first state event based on the play of the second game.

10. The method of claim 8, wherein, in response to extracting the channel identifier from the image data, an application associated with the second game of the second channel is automatically installed on the mobile device.

11. The method of claim 8, wherein the coded identifier is a quick response (QR) code.

12. The method of claim 8, wherein the logic circuitry is configured to verify the extracted channel identifier with the gaming machine to link the extracted channel identifier to the second channel identifier.

13. The method of claim 8, wherein the cross-channel instance is removed in response to at least one of the first gaming session or the second gaming session concluding.

14. The method of claim 8, wherein the one or more respective state actions includes awarding at least one of a number of free spins, a number of wild symbols, or a number of bonus trigger symbols within the first game.

15. A cross-channel server in communication with a gaming machine and a mobile device associated with a player, the gaming machine comprising a presentation assembly configured to present a first game associated with a first channel of a plurality channels, wherein the player is associated with a first gaming session including play of the first game at the gaming machine, the cross-channel server comprising logic circuitry comprising one or more processors and one or more memory devices configured to store instructions that, when executed by the one or more processors, causes the logic circuitry to:
manage a cross-channel instance including the first channel and a second channel associated with a second game, the cross-channel server storing a plurality of state events for the cross-channel instance, each state event of the plurality of state events linked to one or more respective state actions;
cause the gaming machine to present, via the presentation assembly, a coded identifier associated with the cross-channel instance, the coded identifier including a channel identifier associated with the first channel;
in response to at least one image sensor of the mobile device capturing image data including the coded identifier, receive the captured image data and extract the channel identifier from the image data by analyzing pixels of the image data representing the coded identifier;
link the extracted channel identifier of the first channel and a second channel identifier associated with the second channel to the cross-channel instance;
extract at least one cross-channel data element from the second channel based on a second gaming session including play of the second game; and
in response to detecting a first state event of the plurality of state events from the at least one cross-channel data element, cause the first channel to automatically perform at least one of the one or more respective state actions linked to the first state event.

16. The cross-channel server of claim 15, wherein the presentation assembly is configured to present a state meter to visually indicate progress towards the first state event based on the play of the second game.

17. The cross-channel server of claim 15, wherein, in response to extracting the channel identifier from the image data, an application associated with the second game of the second channel is automatically installed on the mobile device.

18. The cross-channel server of claim 15, wherein the logic circuitry is configured to verify the extracted channel identifier with the gaming machine to link the extracted channel identifier to the second channel identifier.

19. The cross-channel server of claim 15, wherein the cross-channel instance is removed in response to at least one of the first gaming session or the second gaming session concluding.

20. The cross-channel server of claim 15, wherein the one or more respective state actions includes awarding at least one of a number of free spins, a number of wild symbols, or a number of bonus trigger symbols within the first game.
